(19) United States
(12) Patent Application Publication
(10) Pub. No.: US 2022/0082784 A1
(43) Pub. Date: Mar. 17, 2022

(54) Optical Member Driving Device, Camera Device and Electronic Apparatus

(71) Applicant: New Shicoh Motor Co., LTD, Zhejiang (CN)

(72) Inventor: Tatsuki WADE, Yamato City (JP)

(21) Appl. No.: 17/478,128

(22) Filed: Sep. 17, 2021

(30) Foreign Application Priority Data
Sep. 17, 2020 (CN) 202010982255.8

(51) Int. Cl. G02B 7/04

(52) U.S. Cl. CPC G02B 7/04

(57) ABSTRACT

An optical member driving device includes a motor, a driven portion, a fixed portion, and a moveable portion. The motor has a piezoelectric board configured by a plurality of piezoelectric elements and formed in an annular shape, and an annular metal board provided on a surface of the piezoelectric board and comprising a plurality of driving surfaces. The driven portion has a driven surface touching against the plurality of driving surfaces that rotates relative to the metal board around an axis passing through a center of the annular shape. The fixed portion is provided with one of the motor and the driven portion. The movable portion has a holding portion for holding an optical member, is provided with the other of the motor and the driven portion, and rotates relative to the fixed portion around the axis.

### CROSS-REFERENCE TO RELATED APPLICATION

This application claims the benefit of Japanese Patent Application No. 202010982255.8 filed Sep. 17, 2020, which is hereby incorporated by reference herein in its entirety.

### TECHNICAL FIELD

The present disclosure relates to an optical member driving device used in electronic apparatus such as smartphones, a camera device, and an electronic apparatus.

### BACKGROUND

Among camera devices used in electronic apparatus such as smartphones, there are some use modules with lens bodies and image sensors as movable portions and perform image stabilizing system by tilting the movable portions around the X axis or the Y axis. As a document disclosing a technique related to this type of camera device, Japanese Patent Application Laid-Open No. 2009-294393A (hereinafter referred to as “Patent Document 1”) can be given. In the optical device for photographing disclosed in Patent Document 1, magnets for image stabilizing system are provided on the outer surfaces opposed to the X direction and the Y direction of a movable portion with a lens, an image pickup device, and a focus mechanism, and a pivot portion is provided at the center of the bottom surface of the fixed portion holding the movable portion, the center of the bottom portion of the movable portion is supported by the pivot portion, and coils for image stabilizing system are provided on the inner surface of the fixed portion. In this device, when a current flows through the coil, the movable portion tilts about a point supported by the pivot portion.

### SUMMARY

However, in the case of the technique of Patent Document 1 there is a problem that, the driving force is insufficient when a large driving force is required, and in order to obtain a sufficient driving force, the device itself becomes upsizing.

The present disclosure has been made in view of such problem, and an object thereof is to provide an optical member driving device capable of obtaining a large driving device even with a small size.

In accordance with a first aspect of the present disclosure, there is provided an optical member driving device including: a motor which has a piezoelectric board configured by a plurality of piezoelectric elements and formed in an annular shape, and an annular metal board provided on a surface of the piezoelectric board and having a plurality of driving surfaces formed by providing a plurality of notches in a radial direction and a thickness direction of the metal board; a driven portion which has a driven surface touching against the plurality of driving surfaces and rotates relative to the metal board around an axis passing through a center of the annular shape; a fixed portion provided with one of the motor and the driven portion; and a movable portion which has a holding portion for holding an optical member, is provided with the other of the motor and the driven portion, and rotates relative to the fixed portion around the axis.

In accordance with a second aspect of the present disclosure, there is provided a camera device including the optical member driving device described above.

In accordance with a third aspect of the present disclosure, there is provided an electronic apparatus including the camera device described above.

Further features of the present invention will become apparent from the following description of exemplary embodiments (with reference to the attached drawings).

### BRIEF DESCRIPTION OF THE DRAWINGS

FIG. 1 is a front view of a smartphone on which a camera device is mounted, the camera device including an optical member driving device according to an embodiment of the present disclosure;

FIG. 2 is a perspective view of the optical member driving device shown in FIG. 1;

FIG. 3 is an exploded perspective view of the optical member driving device shown in FIG. 2;

FIG. 4 is a perspective view in which the cover is removed from the optical member driving device shown in FIG. 2;

FIG. 5 is a perspective view in which a first FPC, a second FPC, and a bottom board are removed from the optical member driving device shown in FIG. 4;

FIG. 6 is a perspective view of FIG. 5 as viewed from another angle;

FIG. 7 is a view of FIG. 5 viewed from the −Y side of the optical member driving device;

FIG. 8 is a cross-sectional view taken along line A-A of FIG. 5; and

FIGS. 9A and 9B are a view made available for explaining the operation of a motor in the optical member driving device shown in FIG. 2, respectively.

### DETAILED DESCRIPTION

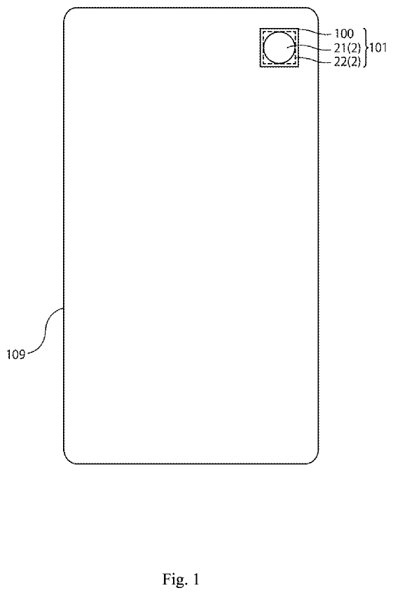

As shown in FIG. 1, a camera device 101 including an optical member driving device 100 according to one embodiment of the present disclosure is accommodated in a housing of a smartphone.

The camera device 101 includes a camera module 2 as the optical member, and an optical member driving device 100 that drives the camera module 2. The camera module 2 includes a lens body 21, an image sensor 22, a lens driving device 23, and a rectangular parallelepiped housing 24 covering them. The image sensor 22 converts the incident light via the lens body 21 into an image signal and outputs the image signal. The lens driving device 23 drives the lens body 21 along a direction parallel to the optical axis thereof.

Here, an XYZ orthogonal coordinate system is used, and the X axis, the Y axis, and the Z axis are orthogonal to each other. The optical axis direction of the lens body 21 is in parallel to the Z direction in an initial state. Further, the side of the subject viewed from the lens body 21 may be referred to as the +Z side, and the opposite side (the image sensor 22 side) may be referred to as −Z side.

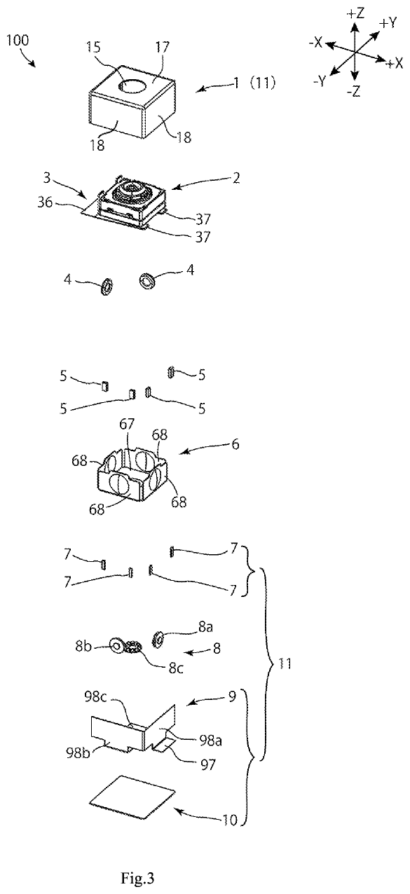

As shown in FIG. 3, the optical member driving device 100 includes three motors 8a, motors 8b, and motors 8c, a driven portion 660, a fixed portion 11, and a movable portion (holder 6).

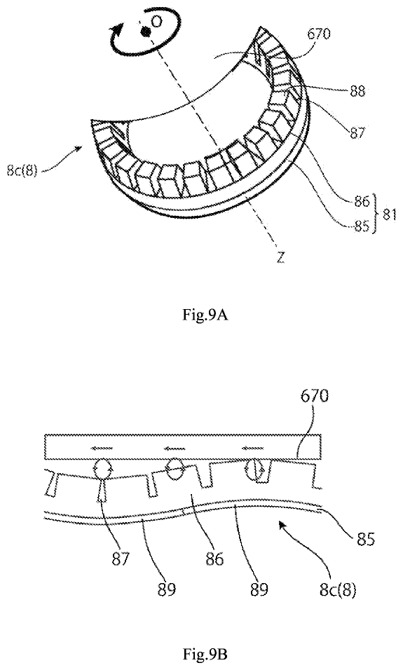

As shown in FIGS. 9 A and 9B, the motor 8 has a piezoelectric board 85 and a metal board 86. The piezoelectric board 85 is configured by a plurality of piezoelectric elements 89 and formed in an annular shape. The metal board 86 is provided on the surface of the piezoelectric board 85 in an annular shape and has a plurality of driving surfaces 88 formed by providing a plurality of notches 87 in the radial direction and the thickness direction of the metal board 86. In the present embodiment, the motor 8 uses three motors 8a, 8b, and 8c.

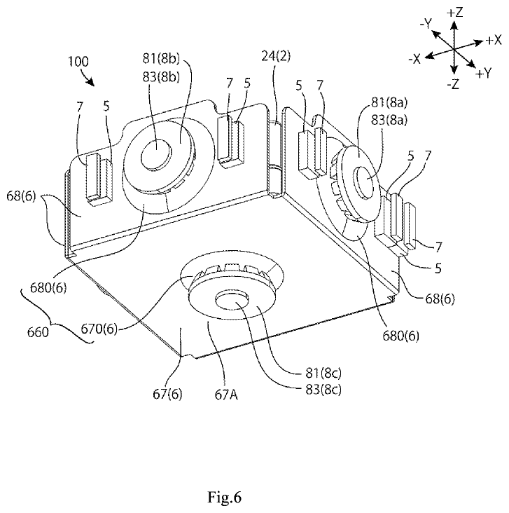

In the present embodiment, as show in FIG. 6, the driven portion 660 corresponds to the portions of the holder 6 provided with the driven surfaces 670, 680, and has driven surfaces 670, 680 which are receiving surfaces touching against the plurality of driving surfaces 88. The driven portion 660 rotates relative to the metal board 86 around the axis (the Z axis in FIG. 9A) passing through the center O of the annular shape of the motor 8.

In the present embodiment, the cover 1, the second FPC 9, and the bottom board 10 correspond to the fixed portion 11, and two rotation support portions 4 and four position detecting sensors 7 also belong to the fixed portion 11. Further, in the present embodiment, a motor 8 is provided.

In the present embodiment, portions of the holder 6 excluding the portions provided with the driven surfaces 670, 680 correspond to the movable portion, and the first FPC 3 and four position detecting magnets 5 also belong to the movable portion. The holder 6 has a rear board 67 as a holding portion 67A for holding the camera module 2 which is an optical member, and is provided with the driven surfaces 670, 680 of the driven portion 660. Thereby, the movable portion rotates relative to the fixed portion 11 around the axis of the motor 8. However, in the present embodiment, the driven surfaces 670, 680 are configured by a portion of a metal board which constitutes the holder 6 as described later, therefore, the driven surfaces 670, 680 also constitute a portion of the movable portion.

The cover 1 has a quadrangular front board 17, and four side boards 18 extending from four sides of the front board 17 to the −Z side. The cover 1 and the quadrangular bottom board 10 are combined as a housing. A through hole 15 is provided in the front board 17 of the cover 1. The cover 1 and the bottom board 10 surround the holder 6 and are opposed to the holder 6.

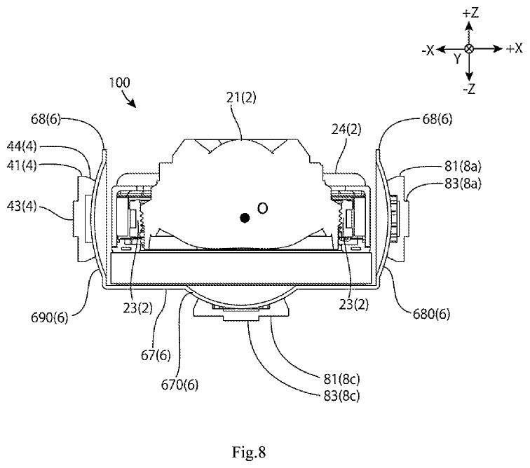

The camera module 2 is accommodated in the holder 6. The holder 6 is a piece of metal board with elasticity, and has a rear board 67 as a horizontal portion and four side boards 68 which are bent and rise from four sides of the rear board 67. The rear board 67 is square-shaped. The side boards 68 have an inverted T-like shape. As shown in FIG. 8, the center of the rear board 67 bulges to the −Z side opposite to the side where the camera module 2 is located as a driven surface 670. As shown in FIG. 6, the periphery of the driven surface 670 of the rear board 67 is a holding portion 67A that holds the camera module 2. The centers of the side boards 68 on the +X side and the −Y side bulge to the +X side and the −Y side opposite to the side where the camera module 2 is located as the driven surfaces 680. The centers of the side boards 68 on the −X side and the +Y side bulge to the −X side and the +Y side opposite to the side where the camera module 2 is located as the sliding surfaces 690. For example, the driven surfaces 670, 680 and the sliding surfaces 690 are convex spherical surfaces formed by press processing. The two driven surfaces 680 and the two sliding surfaces 690 have the same shape and the same size. The center O of the driven surfaces 670, 680 and the sliding surfaces 690 is located at and coincident with the center of the holding portion 67A which is the center of the camera module 2. The axis of each motor 8 passes through the center O of the convex spherical surfaces in the driven surfaces 670, 680. There is a gap between the end edges of the adjacent side boards 68.

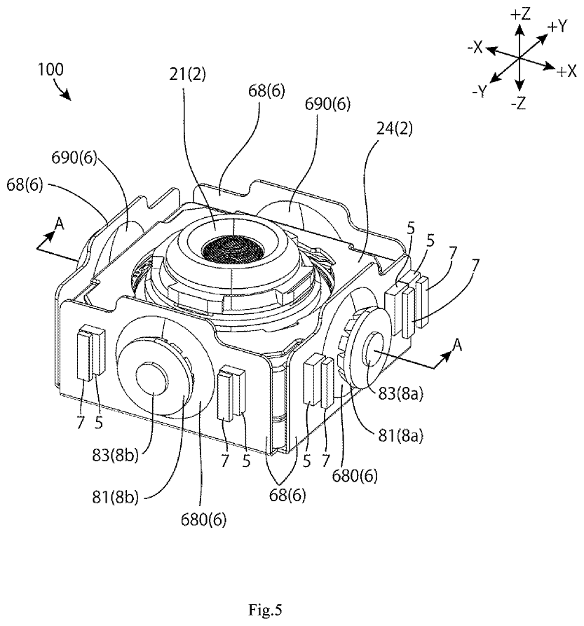

As shown in FIG. 5, one position detecting magnet 5 is provided on each of the two sides of the Y direction sandwiching the driven surface 680 in the outer surface of the side board 68 on the +X side and the two sides of the X direction sandwiching the driven surface 680 in the outer surface of the side board 68 on the −Y side. The position detecting magnets 5 are magnetized so that the surfaces facing the outside become mutually reverse magnetic poles on the +Z side and the −Z side. The position detecting magnets 5 are used to detect the rotation of the camera module 2 held by the holder 6 around the axes in the X direction and the Y direction. Another position detecting magnet 5 is provided on the side boards 68 on the +Y side of the position detecting magnet 5 on the +X+Y side. This position detecting magnet 5 is magnetized so that the surface facing the outside become mutually reverse magnetic poles on the +Y side and the −Y side. This position detecting magnet 5 is used to detect the rotation of the camera module 2 held by the holder 6 around the axis in the Z direction.

The first FPC3 is arranged on the rear side of camera module 2. The first FPC3 has an outer connection portion 36 parallel to the XY plane, and two strip members 37 extending to +X side from two locations on the +Y side and the −Y side of the end edge of the outer connection portion 36. The two strip members 37 are folded back to the −X side on the rear side of the end portion on the +X side of the camera module 2, and the folded tips penetrate the holder 6 and are connected to the camera module 2.

The second FPC 9 is placed and fixed on the front surface of the bottom board 10. The second FPC9 is arranged on the front surface to cover the holder 6 on the +X side, the −Y side, and the −Z side. The second FPC9 has a first board portion 98a parallel to the YZ plane, a second board portion 98b parallel to the XZ plane, a third board portion 98c parallel to the XY plane, and an outer connection portion 97 bent and projecting from the rear end of the first board portion 98a to the −X side.

The first board portion 98a and the second board portion 98b have a T-like shape. The end edge of the first board portion 98a on the −Y side and the end edge of the second board portion 98b on the +X side intersect at a right angle and are connected to each other. The third board portion 98c has a rectangular shape, and the end edge thereof on the −Y side and the end edge of the second board portion 98b on the −Z side intersect at a right angle and are connected to each other.

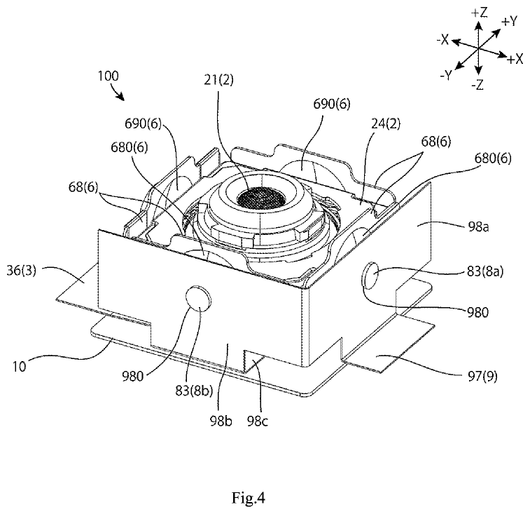

As shown in FIG. 4, the center of each of the first board portion 98a, the second board portion 98b, and the third board portion 98c is provided with a through hole 980. As shown in FIG. 5, five position detecting sensors 7 are provided on two sides in the Y direction sandwiching the through hole 980 in the inner surface of the first board portion 98a and two sides in the X direction sandwiching the through hole 980 in the inner surface of the second board portion 98b, so that one position detecting sensor 7 is opposed to one position detecting magnet 5. The position detecting sensors 7 are Hall elements. The position detecting sensor 7 detects the magnetic field of the position detecting magnet 5 opposed to the position detecting sensor 7 and outputs the signal showing the detection result.

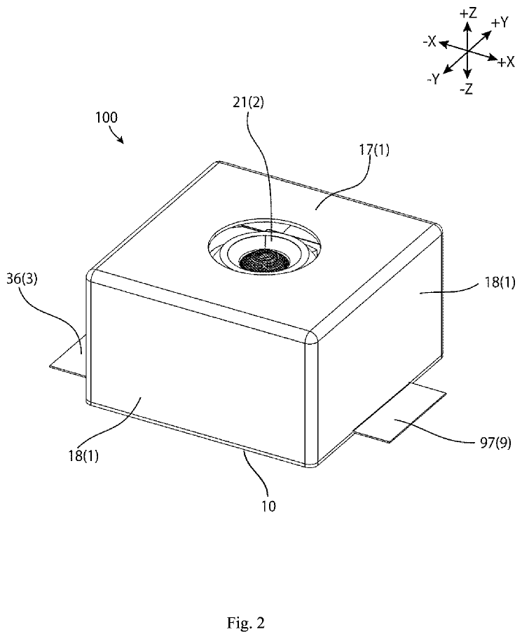

As shown in FIG. 2, through the gap provided between the cover 1 and the bottom board 10, the outer connection portion 36 of the first FPC 3 goes to the outside from the −X side of the optical member driving device 100, and outer connection portion 97 of the second FPC 9 goes to the outside from the +X side. The outer connection portion 36 and the outer connection portion 97 are connected and fixed to an external substrate.

As shown in FIG. 6, each of the motors 8a, 8b, and 8c has a disk portion 81 (see FIG. 9A) configured to have a piezoelectric board 85 and a metal board 86, and a cylindrical convex portion 83 provided at the center of the disk portion 81 and projecting to the opposite side of the driving surface 88. The axis passing through the center of the annular shape of the piezoelectric board 85 and the metal board 86 becomes the rotation center. This convex portions 83 penetrate the through holes 980 (see FIG. 4) and the motors 8a, 8b, 8c are fixed by bonding to the cover 1. The surfaces of the disk portions 81 of the motors 8a, 8b, and 8c opposed to the second FPC 9 are fixed to the first board portion 98a, the second board portion 98b, and the third board portion 98c via flexible members such as elastomer members so as to be deformable. In addition, the surfaces may be in non-contact with other members without via any members. In the present embodiment, the driving surface 88 is a concave spherical surface in which the center O of the concave spherical surface is coincident with that of the driven surfaces 670, 680.

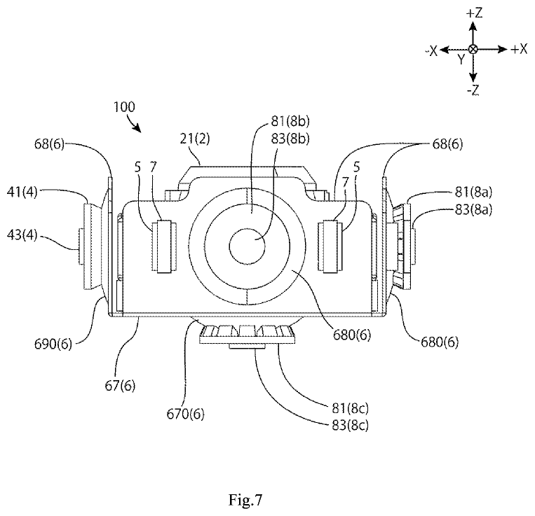

As shown in FIG. 7, the rotation support portion 4 as a whole has the same shape as the motor 8, and has a disk portion 41 touching against the sliding surface 690 and a convex portion 43 projecting from the center of the disk portion 41. As shown in FIG. 8, the touching surface 44 is a concave spherical surface in which the center O of the concave spherical surface is coincident with that of the driven surface 680, but does not need to be divided like the driving surface 88. In the rotation support portion 4, the convex portion 43 is fixed by bonding to the cover 1, but the convex portion 43 may be removed and the disk portion 41 may be directly fixed by bonding. The rotation support portion 4 may by formed of metal or resin with a small friction coefficient. High accuracy and assembly automation become possible by forming the rotation support portion 4 with metal pressing or resin molding.

As shown in FIG. 8, in the X direction, the motor 8a is mounted on the side board 18 of the cover 1 on the +X side and abuts against the driven surface 680 of the holder 6, and the rotation support portion 4 is mounted on the side board 18 on the −X side and abuts against the sliding surface 690 of the holder 6. At this time, the driven surface 680 and the sliding surface 690 of the holder 6 press the motor 8a and the rotation support portion 4 toward the side board 18 by an elastic force that tries to open to the outside of the side board 68 of the holder 6. Thereby, the holder 6 is stably supported between the motor 8a and the rotation support portion 4. The center O of the driven surface 680 and the sliding surface 690 is coincident with the center of the camera module 2 and the axis of the motor 8 extending in the X direction described above passes through this center O. Further, this axis passes through the center of the disk portion 41 of the rotation support portion 4.

As shown in FIGS. 5 and 6, in the Y direction, the motor 8b is mounted on the side board 18 on the −Y side and abuts against the driven surface 680 of the holder 6, and the rotation support portion 4 is mounted on the side board 18 on the +Y side and abuts against the sliding surface 690 of the holder 6. At this time, the driven surface 680 and the sliding surface 690 of the holder 6 press the motor 8b and the rotation support portion 4 toward the side board 18 by an elastic force that tries to open to the outside of the side board 68 of the holder 6. Thereby, the holder 6 is stably supported between the motor 8b and the rotation support portion 4. The center O of the driven surface 680 and the sliding surface 690 is coincident with the center of the camera module 2, is also coincident with the center O (see FIG. 8) of the driven surface 680 and the sliding surface 690 in the X direction. Further, the axis of the motor 8b extending in the Y direction passes through this center O, and this axis passes through the center of the disk portion 41 of the rotation support portion 4.

In the Z direction, the motor 8c is mounted on the bottom board 10 and the driving surface 88 abuts against the driven surface 670 of the holder 6. At this time, the displacement of the driven surface 680 and the sliding surface 690 to the +Z side is hindered by the +Z side of the driving surfaces 88 of the motors 8a, 8b and the +Z side of the touching surface 44 of the rotation support portion 4, so that the driven surface 670 always touches against the driving surface 88 of the motor 8c. The center O of the driven surface 670 is coincident with the center O of the driven surface 680. The axis extending in the Z direction of the motor 8c passes through this center O, and the axis is coincident with the optical axis in the initial state.

With the above configuration, the camera module 2 held by the holder 6 is rotatably supported in the X, Y, and Z directions together with the holder 6. Thus, is rotates around the X axis by the motor 8a, rotates around the Y axis by the motor 8b, and rotates around the Z axis by the motor 8c.

When a voltage is applied to each piezoelectric element 89 of the piezoelectric board 85 as shown in FIG. 9A, each piezoelectric element 89 expands and contracts according to the voltage, but the metal board 86 does not expand or contract. Thereby, the disk portion 81 is deformed in the circumferential direction so that the driving surface 88 generates a protruding portion and a recessed portion as a whole. At that time, as shown in FIG. 9B, the interval between the adjacent driving surfaces 88, that is, the width of the notch 87, changes. For example, such a deformation can be generated by applying a rectangular wave with a resonance frequency to each piezoelectric element 89. Further, by changing the phase, as shown in FIG. 9B, the driving surface 88 performs an elliptical motion along the circumferential direction. For example, when the driven surface 670 of the holder 6 is moved in a clockwise direction around the axis along the Z direction, a voltage is applied so as to make an elliptical motion that it moves in a clockwise direction when the driving surfaces 88 arranged in annular shape project.

The above are the details of the configuration of the present embodiment. The optical member driving device 100 in the present embodiment includes: a motor 8 which has a piezoelectric board 85 configured by a plurality of piezoelectric elements 89 and formed in an annular shape, and an annular metal board 86 provided on the surface of the piezoelectric board 85 and having a plurality of driving surfaces 88 formed by providing a plurality of notches 87 in a radial direction and a thickness direction of the metal board 86; portions of the driven surfaces 670, 680 of the holder 6 as the driven portion 660 which has the driven surfaces 670, 680 touching against a plurality of driving surfaces 88 and rotates relative to the metal board 86 around the axis passing through the center of the annular shape; a fixed portion 11 provided with one of the motor 8 and the driven portion 660; and the holder 6 as the movable portion which has a holding portion 67A for holding the camera module 2 as the optical member, is provided with the other of the motor 8 and the driven portion 660, and rotates relative to the fixed portion 11 around the axis. Since in the motor 8, the driving surfaces 88 touch against the driven surfaces 670, 680 of the driven portion 660 and rotate, even if the motor 8 is small, the driving force is large. As a result, it is possible to provide an optical member driving device 100 capable of obtaining a large driving force even if it is small.

In addition, in the embodiment described above, it is desirable that the holder 6 presses the motor 8c from the front side by a spring member or the like so that the driving surface 88 and the driven surface 670 stably abut against each other. As the spring member, a plate spring may be used, the bottom board 10 may be warped so that the central portion of the bottom board 10 is slightly in front side of the peripheral portion, and the convex portions 83 of the motors 8a, 8b and the convex portion 43 of the rotation support portion 4 may be fixed slightly behind the original position and pressed by the elastic force of the holder 6 which is an elastic member. In addition, even if it is not a spring member, for example, an attractive force or a repulsive force between a magnet and a magnetic body or a magnet may be used.

In addition, in the embodiment described above, instead of arranging the motor 8c and the driven surface 670, only the motors 8a, 8b and the driven surface 680 may be arranged to drive the holder 6 around the two axes in the X direction and the Y direction. In addition, the rotation support portion 4 may be replaced with the motor 8. In that case, the sliding surface 690 becomes the driven surface 680.

The optical member is not limited to the camera module 2. For example, it may be a prism. A motor and a driven portion may be provided on one side surface side, which is not an incident surface, a reflecting surface, or an emitting surface of light, and a rotation support portion and a sliding surface may be provided on the other side surface side, and the motor may be rotated around the axis in the normal direction of the side surface.

The driving surface 88 may be a flat surface as a whole. In addition, each driving surface 88 may be a flat surface, and the normal line of the flat surface may pass through the center O of the driven surfaces 670, 680. In addition, the driving surface 88 may be a conical surface whose normal line passes through the center O of the driven surfaces 670, 680. Similarly, the touching surface 44 may be a conical surface whose normal line passes through the center O of the sliding surface 690. In addition, the sliding surface 690 may be supported by three-point contact as a touching surface 44.

The driven surfaces 670, 680 constituting the driven portion 660 are configured by the metal board constituting the holder 6, but the driven portion 660 may be configured by other members to form the driven surfaces 670, 680, and for example, it may be fixed by bonding to the holder 6. Regardless of the elasticity of the holder 6, it is easy to obtain an appropriate friction and abrasion state with the driving surface 88. In addition, the driving surface 88 does not have to be the material itself of the metal board 86, and any surface treatment may be performed, or treatment may be performed to change the friction and abrasion state with the driven surfaces 670, 680. The same applies to the sliding surface 690 and the touching surface 44.

The motor 8 may be provided at the movable portion, and the driven portion 660 may be provided at the fixed portion 11. In that case, it is desirable that the driven surfaces 670, 680 of the driven portion 660 are concave spherical surfaces. In addition, in that case, the centers 0 of the concave spherical surfaces may be coincident.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

What is claimed is:

1. An optical member driving device comprising:
a motor which comprises a piezoelectric board configured by a plurality of piezoelectric elements and formed in an annular shape, and an annular metal board provided on a surface of the piezoelectric board and comprising a plurality of driving surfaces formed by a plurality of notches in a radial direction and a thickness direction of the metal board;
a driven portion which comprises a driven surface touching against the plurality of driving surfaces and rotates relative to the metal board around an axis passing through a center of the annular shape;
a fixed portion provided with one of the motor and the driven portion; and
a movable portion which comprises a holding portion for holding an optical member, is provided with the other of the motor and the driven portion, and rotates relative to the fixed portion around the axis.

2. The optical member driving device according to claim 1, wherein the driven surface of the driven portion provided at the movable portion is a convex spherical surface facing a side opposite to the optical member side, and the axis passes through a center of the convex spherical surface.

3. The optical member driving device according to claim 2, wherein the driven surface and a convex spherical surface of the same shape as the driven surface are provided on two sides with the holding portion sandwiched therebetween, and center of the two convex spherical surfaces is located at and coincident with a center of the holding portion.

4. The optical member driving device according to claim 3, wherein:
the fixed portion surrounds the movable portion and is opposed to the movable portion,
the driving surfaces of the motor touch against the driven surface, and
a concave spherical surface, a conical surface, or a touching surface with three touching points of a rotation receiving portion provided at the fixed portion, or driving surfaces of another motor touch against a convex spherical surface of the same shape as the driven surface.

5. The optical member driving device according to claim 4, wherein:
the movable portion comprises a holder, and the holder is formed by bending an elastic member at a horizontal portion provided with the holding portion and two side portions provided with the driven surfaces, and
the holder presses the motor, and a convex spherical surface of the same shape as the driven surface presses the rotation receiving portion or another motor.

6. The optical member driving device according to claim 3, wherein the driven surface and the convex spherical surface of the same shape as the driven surface are further provided on the other two sides with the holding portion sandwiched therebetween, a center of the four convex spherical surfaces is located at and coincident with the center of the holding portion, and the two axes are orthogonal to each other.

7. The optical member driving device according to claim 6, wherein another driven surface is further provided, a center of the five convex spherical surfaces is located at and coincident with the center of the holding portion, and the three axes are orthogonal to each other.

8. The optical member driving device according to claim 1, wherein the piezoelectric board on a side opposite to the side where the metal board is provided is held by the fixed portion or the movable portion via an elastomer member.

9. The optical member driving device according to claim 5, further comprising a second FPC having a first board portion, a second board portion and a third board portion opposed to the horizontal portion and two side portions of the holder,
wherein the first board portion, the second board portion and the third board portion are provided with the motor, respectively.

10. The optical member driving device according to claim 9, wherein position detecting sensors are provided on two sides sandwiching each of the motors provided on the board portions opposed to the two side boards.

11. A camera device comprising the optical member driving device according to claim 1.

12. An electronic apparatus comprising the camera device according to claim 11.
